(19) United States
(12) Patent Application Publication
(10) Pub. No.: US 2012/0038664 A1
(43) Pub. Date: Feb. 16, 2012

(54) MANAGING OCCLUDING OBJECTS IN LAYOUTS OF GRAPHIC OBJECTS

(76) Inventors: Michael Sheasby, Boucherville (CA); Michael Mondry, Nuns' Island (CA); Grayden Wagner, Montreal (CA)

(21) Appl. No.: 13/028,866

(22) Filed: Feb. 16, 2011

Related U.S. Application Data
(60) Provisional application No. 61/304,932, filed on Feb. 16, 2010.

(51) Int. Cl. G09G 5/373

(52) U.S. Cl. 345/629

(57) ABSTRACT

A user may position a graphic object in a layout and the computer automatically knocks out frames to accommodate it. In implementation, a panel or panel set also may allow occluded or overlapping frames to be knocked out automatically in response to a user positioning an object in the layout in the graphical user interface. The computer determines from the size, position and orientation of the object which frames in a panel are overlapping or occluded, marks them as knocked out, and rearranges objects in the panel. As a result, the other images on the page appear to flow around the occluding or overlapping frame. Any textual labels or other information displayed for the occluded or overlapping frames also can be suppressed. A user can overlay as many occluding or overlapping objects as desired over a panel. Automatically knocking out occluded or overlapping frames streamlines the process of laying out complex panel designs, because the user can reposition and resize objects without needing to manually knock out the potentially many panel frames that overlap or occlude another object.

### CROSS REFERENCE TO RELATED APPLICATIONS

This application is a nonprovisional application for which the applicant claims, under 35 U.S.C. §119, priority to and the benefits of U.S. provisional patent application Ser. No. 61/304,932, filed on Feb. 16, 2010, which is hereby incorporated by reference.

### BACKGROUND

Several computer-based tools are available that allow a user to produce an arrangement or layout of images and other graphic objects, such as wedding albums, calendars, scrapbooks, catalogs and school yearbooks. Such tools typically include a database that associates information with the images to be arranged, such that a query on the information enables images to be retrieved. For example, for a school yearbook, the database may associate student names, grades, and teacher names with an image of a student.

The design problem faced by a designer to produce such arrangements is constructing one or more pages with the images arranged in some order, usually based on their associated information. By way of example, one arrangement commonly used in yearbooks is a regular grid of student images, representing a “class panel,” or a presentation of all the children matching a particular combination of grade and teacher. Most computer-based tools enable the designer to control the layout of this automated arrangement on the page, including the image width, a row and/or column count, the position and content of labels associated with the images, and other options.

Some tools enable a designer to “knock out” frames from a grid of frames in which the images are laid out. That is, if a panel holds 20 images in a 4×5 grid, then the tool enables the designer to select a frame in the grid and indicate that it is to remain empty. A frame may be knocked out to leave a space in the grid for another image that is not based on the database query being used to fill the grid. For example, one or more frames at a center of a grid in a yearbook page may be knocked out to allow the designer to insert a candid picture of the class. Multiple frames can be knocked out on a single page, for example to achieve an artistic goal, e.g., forming the grid into a triangle.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Instead of asking the user to knock out frames and then position an element in place of the knocked out frame, the user may position the element and the computer automatically knocks out frames to accommodate it. In implementation, a panel or panel set also may allow occluded or overlapping frames to be knocked out automatically in response to a user positioning an object in the layout in the graphical user interface. The computer determines, from the size, position and orientation of the object, which frames in a panel are overlapping or occluded and marks them as knocked out. Objects that occupy the frames can be rearranged within the frames that are not knocked out. As a result, the images on the page appear to flow around the occluding or overlapping object. Any textual labels or other information displayed for the occluded or overlapped frames also can be suppressed. A user can overlay as many occluding or overlapping objects as desired over a panel. Automatically knocking out occluded or overlapped frames streamlines the process of laying out complex panel designs, because the user can reposition and resize objects without needing to manually knock out the potentially many panel frames that are overlapped or occluded by another object.

A panel set may be expanded or contracted, so that the panels provide enough frames for the image or other objects to occupy. Also, the pattern of the frames in the panel can be adjusted to fit a desired number of pages or panel sets.

Accordingly, in one aspect, a computer program product comprises a computer readable storage medium with computer program instructions stored on the computer readable storage medium that, when processed by a computer, instruct the computer to perform several operations. In another aspect, a computer system comprises a processor and a storage device that stores instructions that, when processed by a computer, instruct the computer to perform several operations. In another aspect, a computer-implemented process uses a processor and storage that stores instructions that, when processed by a computer, instruct the computer to perform several operations.

The computer establishes in memory a data structure representing a managing object, wherein the managing object manages a two-dimensional spatial layout of a first collection of managed frames in a pattern for positioning a second collection of graphic objects, wherein each of the graphic objects in the second collection occupies one or more of the managed frames in the first collection. The computer establishes in memory a data structure representing a second object, wherein the second object has an occluding relationship with the managing object, and has a position in the two-dimensional spatial layout. The computer identifies managed frames in the first collection of frames which overlap with the second object. For each of the graphic objects, the computer selects one or more of the managed frames for the graphic object to occupy from among the frames that do not overlap with the second object.

### DESCRIPTION OF THE DRAWINGS

FIG. 1 is a diagram of an example computer system used for creating a layout of graphic objects.

FIG. 2 illustrates a data structure for a layout.

FIG. 3 illustrates a data structure for a panel set.

FIG. 4 is a flowchart describing how a frame in a panel is automatically knocked out due to an occluding or overlapping object.

FIGS. 5-7 are illustrations of a panel set that is modified due to an occluding object.

### DETAILED DESCRIPTION

In the following description, reference is made to the accompanying drawings, which form a part thereof, and which show, by way of illustration, example implementations. Other implementations may be made without departing from the scope of the claimed subject matter.

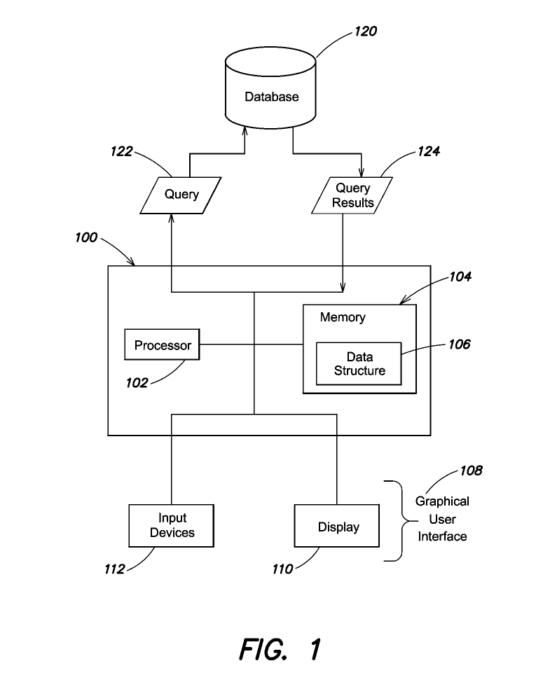

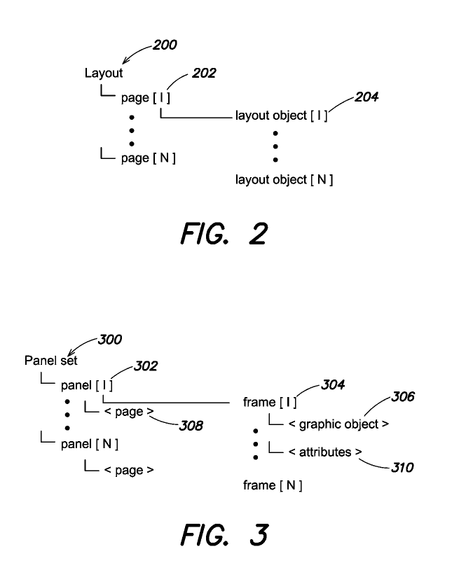

FIG. 1 is a diagram of an example computer system used for creating a layout of graphic objects. FIG. 2 illustrates a data structure for a layout.

Referring to FIG. 2, a layout 200 of a set of graphic objects comprises one or more pages 202, with each page comprising a list of one or more layout objects 204. Each layout object is either a graphic object or a collection of graphic objects and has a size, position and orientation with respect to an origin.

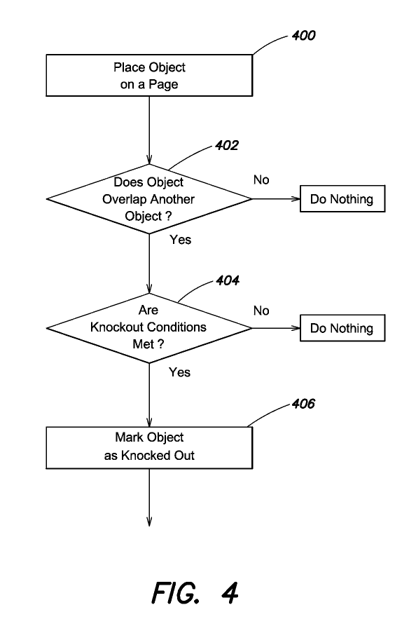

One type of collection of graphic objects herein is called a panel object. See FIG. 3. The panel object 302 manages a two-dimensional spatial layout of a panel, which is a first collection of frames 304 in a desired pattern, for positioning a second collection of graphic objects 306. Each of the graphic objects in the second collection occupies one or more of the frames in the panel. Thus, each panel includes one or more frames, each of which may include a graphic object and may also have associated attributes 310, such as text. One or more panels may be defined by a panel set 300, each panel of which is associated with one of the pages 308, but which are managed collectively. Panel objects and panel sets are described in more detail below.

Each layout object, or frame of a panel, has a position, orientation and size (e.g., height and width) with respect to an origin, which is usually a position on, and orientation of, a page. Among the layout objects on a page, each layout object may have an order, or “z-position” or “z-order” which indicates which layout object is on top. An object with a higher “z” value than another object indicates the object that is “on top” of the other object. This order may be explicit, or may be implicit, such as the order in which the layout objects are placed in a list of layout objects, or the order in which the objects are rendered onto a page for display or other output.

Example graphic objects include, but are not limited to, digital images, digital photographs, digital line drawings, etc. Data representing graphic objects generally are stored in computer data files in known file formats, examples of which include, but are not limited to, image files (in raster formats such as .jpg, .png, .bmp, .gif files or vector formats such as .AI, .SVG, .PDF, .EMF, .WMF), text frames (in which textual information is laid out according to rules and formats such as HTML, Rich Text (.rtf, or ‘native’ formatting instructions) or video frames (which contain time-based video sequences, in formats such as .mpg, .mov, .avi, .wmv, .fla) and the like.

Referring to FIG. 1, a computer system 100, i.e., a machine that is typically a programmed general purpose computer, includes a processor 102 that receives and processes instructions based on a computer program, and a memory 104 connected to the processor and which stores instructions and data. The processor establishes in memory 104 a data structure 106 representing the layout, such as described above in connection with FIG. 2. The computer system 100 also may be connected to a display 110 and one or more input devices 112 to provide for interaction with a user. A graphical user interface 108 may be provided through the display 110 and input devices 112. Through the graphical user interface, the computer system presents to a user a graphical representation of the layout, and allows the user to manipulate the layout by placing and manipulating various layout objects on one or more pages using the input device(s).

The computer system also may allow the user to create more complex layouts by associating one or more database queries with a panel set. The computer system 100 is connected to a database 120, i.e., a machine that implements a database such as a relational database or object oriented database, which is responsive to queries 122 to provide query results 124. The database, for example, stores graphic objects associated with various metadata, such as a names, dates, geographical locations and other labels. A user specifies a query 122 and the database provides as query results 124 (the graphic objects, and their metadata, which match the query). The query results are used to populate the list of layout objects for the panel set, which may include creating multiple pages, each with a panel with multiple layout objects.

In addition to including graphic objects, the layout can include metadata or other attributes associated with the graphic object. For example, the name of a person can be displayed as a label next to a picture of the person.

Through the graphical user interface, as one of the operations for manipulating the layout, a user is allowed to add a new layout object to a page, and position it over other panels and graphic objects on the page. The new layout object may overlap other layout objects. In such a case, one of the objects can be considered “occluding.” Any frame or object that is partially covered by an occluding object is called “occluded.” In some cases, the designer wants such overlap to occur. Also, it is possible for the designer to manually indicate that an occluded frame should be “knocked out,” which means that the frame in the panel should not be used. A designer may knock out a few frames in a panel to introduce a gap in a layout to leave room for another design element.

Instead of asking the user to knock out frames and then position an element in place of the knocked out frame, the user may position the element and the computer automatically knocks out frames to accommodate it. In implementation, a panel or panel set also may allow occluded or overlapping frames to be knocked out automatically in response to a user positioning an object in the layout in the graphical user interface. The computer determines, from the size, position and orientation of the object, which frames in a panel are overlapping or occluded and marks them as knocked out. Objects that occupy the frames can be rearranged within the frames that are not knocked out. As a result, the images on the page appear to flow around the occluding or overlapping object. Any textual labels or other information displayed for the occluded or overlapped frames also can be suppressed. A user can overlay as many occluding or overlapping objects as desired over a panel. Automatically knocking out occluded or overlapped frames streamlines the process of laying out complex panel designs, because the user can reposition and resize objects without needing to manually knock out the potentially many panel frames that are overlapped or occluded by another object.

To determine whether an object may occlude a frame in a panel, the computer evaluates whether the object overlaps the frame. For example, if a z-order is either explicit or implicit in the list of object, then an object may occlude a frame if it is higher in the Z order of the composition. If an object is higher in the Z order than a frame, and has a geometry that intersects with the geometry of the frame, then the object may occlude the frame. This process is described in more detail below in connection with FIG. 4.

In another implementation, whether a frame is knocked out can be further conditioned upon the state of one or more occlusion properties or attributes of that frame. In this implementation, each of the objects involved in the interaction may expose a property enabling or disabling automatic knockouts due to occlusion. For example, each individual panel frame may expose a ‘knockout in case of occlusion” property, or each panel or panel set (e.g. the collection of panel frames) may expose a “knockout child frames when they are occluded” property, or each potentially occluding object in the system may expose a “consider as an occluding object” property. If the combination of these properties produces occlusion (both the frame and its panel indicate knockouts should occur, and the object can be an occluding object) then frames will be knocked out; otherwise, frames will not be knocked out.

Knocking out a frame of a panel, and then rearranging objects in a panel, can have the effect of increasing the number of pages used by the panel set. For example, a class of students that fits on a single page prior to the introduction of an occluding frame may change to spill over across two or indeed many other pages. Likewise the removal of or a change in the occluding frame may cause additional pages to be unnecessary. Thus, a panel set may be expanded or contracted, so that the panels provide enough frames for the image or other objects to occupy. Also, the pattern of the frames in the panel can be adjusted to fit a desired number of pages or panel sets.

Panel objects and panel sets will now be described in more detail. As noted above a panel object is a type of collection of graphic objects. The panel object manages a two-dimensional spatial layout of a panel, which is a first collection of frames in a desired pattern, for positioning a second collection of graphic objects. Each of the graphic objects in the second collection occupies one or more of the frames in the panel, and is typically determined through a query applied to a database. The first collection of frames has exterior dimensions. The positions of the graphic objects in the second collection generally are set without altering the exterior dimensions of the first collection of frames. In other words, for each of the graphic objects in the second collection, one or more frames are selected for the graphic object to occupy.

The desired pattern may take a variety of forms, such as a regular grid, or a grid of differently-sized frames. The frames typically are laid out in a grid, with a number of rows and columns forming a matrix of images. Variations on a grid, such as deformations of the baseline for each row or column (forming waves, triangles, arcs, and other shapes) often add visual interest to the layout. The pattern may be defined by a set of parameters (such as a number of rows and columns, or other values that define a layout of multiple objects). By using a set of parameters, the parameters can be adjusted to make the pattern fit within a layout. The most common requirement of the panel layout, however, is legibility: that a predictable order to images can be detected—making it possible for a viewer to find an individual with a given name or other identifier.

The frames also may have a border. The borders of the frames may be set at a regular distance from one another. Each frame may optionally have an associated label, typically text, which aids a viewer in identifying an individual represented within the graphic object in the frame. The position of the label is up to a designer, so long as the relationship between the label and indicated frame can be inferred. Common label locations include underneath each frame, or stacked vertically at the end of rows of frames.

A panel object or panel set would be used, for example, to create an arrangement of images and text illustrating the members of a group of individuals drawn from a larger set, possibly encapsulated in a database. The data set may represent the population of a school, the congregation of a church, the cadre of a military group, or indeed nonhuman groups such as competitors in a dog show or vehicles for sale by a used car dealership. The data set may be decomposed into groups, each defining a set of similar individuals. Examples include students in a common grade or taught by a common teacher. The individuals that compose the data set and groups may be, for example, students in a school, members of a church, soldiers in a military organization, dogs, or cars.

A group may contain more individuals than can be reasonably displayed within a single panel, for a variety of aesthetic reasons. If this occurs, a panel set is used to manage the multiple panels used to hold all the group members. This panel set implies the existence of a “managing object,” responsible for maintaining the creation of and removal of panels on potentially many pages and assigning individuals to spaces available within the panels managed by that object.

Some examples of aesthetic reasons for a group to flow through multiple panels include the following. When too many individuals are fit within a single page, the implied reduction in the size of the images in the panels may reduce the space available for textual labels attached to each frame to the point where the labels are no longer legible. Similarly, if groups cannot be displayed in panels that span multiple pages, they may be required to be so small that individuals can no longer be discerned from their images.

Whether a frame is knocked out manually or implicitly by occlusion, it is possible for the panel set to require additional pages to hold all individuals in the set. To create this effect of having a group flow through to multiple panels, when the objects for the group are arranged (or rearranged) in a panel, the following process is followed. The objects are first positioned in a first panel. If more objects remain after the available frames in the first panel are used, a next panel in the panel set is used. If such a panel does not exist, it is created. If a new page is needed in the layout to accommodate the new panel, then a new page is added to the layout. This process repeats until all the objects for the group are arranged in the panel set. If more panels remain in the panel set that do not have objects in their frames, then these panels may be deleted. Alternatively, parameters defining the pattern of the frames may be adjusted so that the number of panels remains fixed.

Referring now to FIG. 4, how a frame in a panel is automatically knocked out due to an occluding or overlapping object will now be described in more detail.

This process is performed when the display is to be updated. For example, if recomputing the entire layout is computationally expensive and cannot be completed at interactive frame rates, then the laying out of the frames takes place at the completion of user interaction (e.g., when the user releases a resize handle on, or ceases repositioning by direct dragging of, a frame). On the other hand, if the layout calculation can be completed in less than some threshold (such as 1/10 of a second), then the calculation can be triggered for each update of the size, position, or order of potentially occluding or overlapping frames.

After an object is placed (400) on a page, it is determined (402) whether the object overlaps another object on the page. This is a comparison of the geometry of the new object to the geometry of each object on the page. When evaluating an object's geometry, its bounding box may be used, or transparent regions in the object may be considered. The bounding box of a rotated object may be its original bounding box, but rotated, or may be a bounding rectangle aligned with the display axes of the rotated object. Any label or other displayed attribute or metadata associated with the object also may be considered when evaluating an object's geometry. If an object on the page is a collection of objects, then each object in the collection of objects is examined only if there is some possible overlap between the new object and the whole collection.

If two objects overlap, it is then determined (404) whether a frame should be automatically knocked out. One graphical object A can be considered to occlude another B if certain conditions are met. Some examples include, but are not limited to: whether A is a type of object to be considered when determining occlusion, whether the z-order for A is higher than B, whether the intersection of A's geometry and B's geometry is non-empty. Each condition in the set of conditions can be individually enabled for each object or type of object in a layout. Setting up conditions in this way provides flexibility in the behavior in response to occluding objects. For example, even if a panel B is in front of an object A, it may be desirable for frames in B to be knocked out to allow A to be visible (so the z-order condition may not be necessary).

If it is determined that a frame should be automatically knocked out, then that frame can be marked (406) as knocked out.

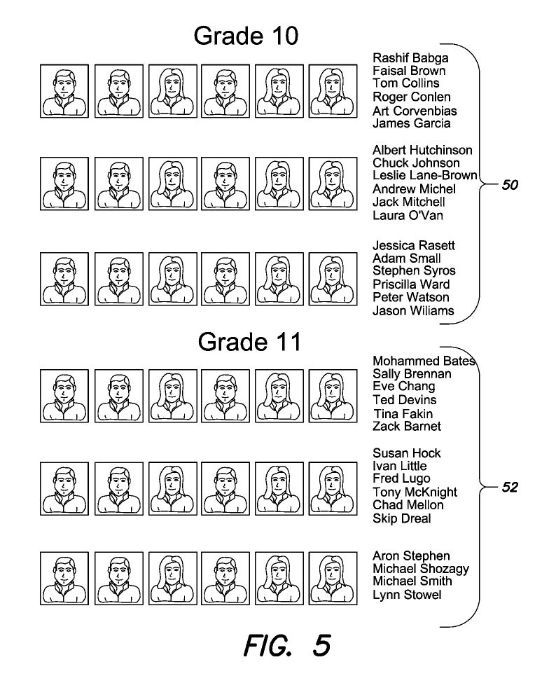

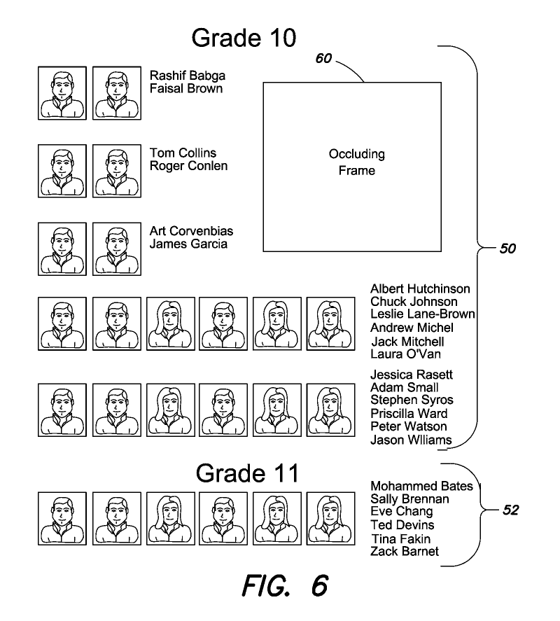

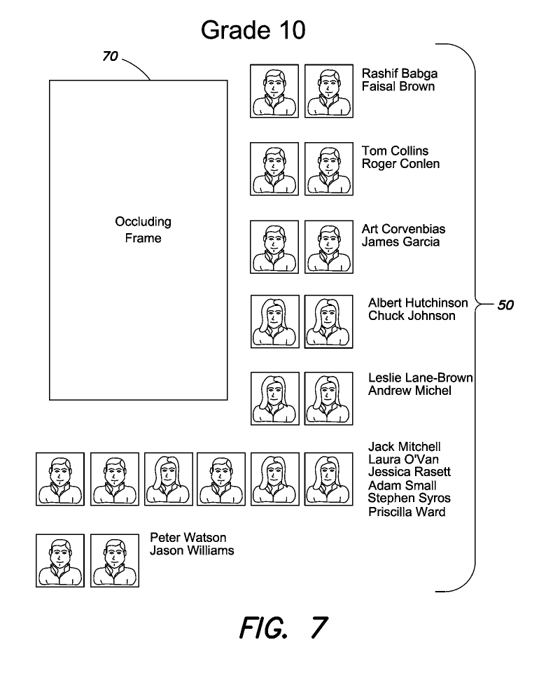

FIG. 5 illustrates an example layout prior to introduction of an occluding frame. A page holding two panels 50, 52 is illustrated. The top panel 50 contains 18 frames of a grade 10 class, and the bottom panel 52 contains 16 frames of a grade 11 class. FIG. 6 illustrates this layout with an occluding frame 60 added. The frame 60 has been placed over top of the Grade 10 class. The number of students in grade 10, panel 50, has remained at 18. The Grade 11 class in panel 52 continues to start after the end of the grade 10 class, but only 6 of the 16 students are visible; the rest have been moved to a subsequent page. FIG. 7 illustrates this layout with the occluding frame 60 resized. The occluding frame has been translated left and resized vertically. The panel set 50 has reflowed around the occluding frame. Note that Grade 11 in panel set 52 has now been completely pushed to the following page (not shown).

A panel set is an example of a managed object—a ‘parent’ geometry, including position/width/height/angle, which contains and controls a set of ‘child’ objects (the individual frames, each holding one student image). Above the managed panel object may be some abstract object, a behavior or manager, which constructs managed pages based on some algorithm. For example a yearbook panel behavior can maintain a database query (“find all students in all grades, and clump them into groups based on their teacher names, then sort those groups by the grade they represent”).

The techniques described above can be implemented in digital electronic circuitry, or in computer hardware, firmware, software executing on a computer, or in combinations of them. The techniques can be implemented as a computer program product, i.e., a computer program tangibly embodied in tangible, machine-readable storage medium, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions described herein by operating on input data and generating output. Method steps can also be performed by, and apparatus of the invention can be implemented as, special purpose logic circuitry, e.g., an FPGA (field programmable gate array) or an ASIC (application-specific integrated circuit). Applications can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Storage media suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A computing system can include clients and servers. A client and server are generally remote from each other and typically interact over a communication network. The relationship of client and server arises by virtue of computer programs running on the respective computers and having a client-server relationship to each other.

Having described an example embodiment, it should be apparent to those skilled in the art that the foregoing is merely illustrative and not limiting, having been presented by way of example only. Numerous modifications and other embodiments are with the scope of ordinary skill in the art and are contemplated as falling with the scope of the invention.

What is claimed is:

1. A computer program product comprising:
a computer readable storage medium;
computer program instructions stored on the computer readable storage medium that, when processed by a computer, instruct the computer to:
establish in memory a data structure representing a managing object, wherein the managing object manages a two-dimensional spatial layout of a first collection of managed frames in a pattern for positioning a second collection of graphic objects, wherein each of the graphic objects in the second collection occupies one or more of the managed frames in the first collection;
establish in memory a data structure representing a second object, wherein the second object has an occluding relationship with the managing object, and has a position in the two-dimensional spatial layout;
identify managed frames in the first collection of frames which overlap with the second object;
for each of the graphic objects, selecting one or more of the managed frames for the graphic object to occupy from among the frames that do not overlap with the second object.

2. The computer program product of claim 1, wherein the one or more frames are selected without altering the pattern of managed frames in the first collection.

3. The computer program product of claim 1, wherein the first collection of managed frames further has exterior dimensions, and wherein the one or more frames are selected without altering the exterior dimensions of the first collection of managed frames.

4. The computer program product of claim 1, wherein the pattern is a regular grid.

5. The computer program product of claim 1, wherein the pattern is a grid of differently-sized frames.

6. The computer program product of claim 5, wherein the frames have a border.

7. The computer program product of claim 6, wherein the borders of the frames are at a regular distance from one another.

8. The computer program product of claim 1, wherein the second collection of graphic objects is defined by a query applied to a database.

9. The computer program product of claim 8, wherein the frames occupied by the graphic objects are interactively selected in response to user input defining the query.

10. The computer program product of claim 1, wherein managed frames in the first collection of frames which overlap with the second object are identified interactively in response to user input modifying the position in the two-dimensional spatial layout of the second object.

11. The computer program product of claim 1, wherein the two-dimensional spatial layout comprises a page, and wherein the managing object creates one or more pages to accommodate enough managed frames in the pattern for the graphic objects to occupy in response to the managed frames being overlapped by the second object.

12. The computer program product of claim 1, wherein the two-dimensional spatial layout comprises a page, and wherein the managing object removes one or more pages to accommodate enough managed frames in the pattern for the graphic objects to occupy in response to the managed frames being overlapped by the second object.

13. The computer program product of claim 1, wherein the two-dimensional spatial layout comprises one or more page, and wherein the managing object modifies the pattern of managed frames to provide enough managed frames within the one or more pages for the graphic objects to occupy in response to the managed frames being overlapped by the second object.
